(19) United States
(12) Patent Application Publication
(10) Pub. No.: US 2017/0184740 A1
(43) Pub. Date: Jun. 29, 2017

(54) DETECTING EARTHQUAKES THROUGH A NETWORK OF GEOGRAPHICALLY DISTRIBUTED SENSORS

(71) Applicant: Zizmos, Inc., Palo Alto, CA (US)

(72) Inventors: Battalgazi Yildirim, Palo Alto, CA (US); Jesse F. Lawrence, Boulder, CO (US); Robert M. Armitano, Palo Alto, CA (US)

(73) Assignee: Zizmos, Inc., Palo Alto, CA (US)

(21) Appl. No.: 15/078,716

(22) Filed: Mar. 23, 2016

Related U.S. Application Data
(60) Provisional application No. 62/272,596, filed on Dec. 29, 2015.

(51) Int. Cl. G01V 1/00

(52) U.S. Cl. CPC G01V 1/008

(57) ABSTRACT

The disclosed embodiments relate to a system that detects earthquakes through a network of geographically distributed sensors. During operation, the system obtains inputs from sensors in the network of geographically distributed sensors. The system then determines from the obtained inputs whether an earthquake is occurring. During this process, the system associates a weight with each sensor, wherein the weight is correlated with an accuracy of the sensor, and then applies the weight to inputs obtained from the sensor while performing computations to determine whether an earthquake is occurring. If an earthquake is occurring, the system sends a warning to one or more subscribers.

### RELATED APPLICATION

This application claims priority under 35 U.S.C. §119(e) to U.S. Provisional Application Ser. No. 62/272,596, entitled “Sensor Network and Alert Distribution System,” by inventors Battalgazi Yildirim, Jesse F. Lawrence and Robert M. Armitano, Attorney Docket Number ZIZ-1001PROV, filed on Dec. 29, 2015, the entire contents of which are herein incorporated by reference.

### BACKGROUND

Field

The disclosed embodiments generally relate to techniques for detecting earthquakes. More specifically, the disclosed embodiments relate to a technique for detecting earthquakes using a network of geographically distributed sensors.

Related Art

Earthquakes that strike large metropolitan areas can be extremely devastating. For example, in 1995, the Great Hanshan Earthquake shook the city of Kobe, Japan, for 20 seconds, ultimately killing 6,400 people and damaging thousands of buildings. Much of this loss of life and devastation can possibly be avoided if an early warning system can be developed to rapidly detect the onset of a major earthquake and send a timely warning to potentially affected people. Note that providing even 10 to 15 seconds of advance warning of an impending earthquake can enable people to avoid harm by: taking cover, stopping driving and turning off gas mains.

However, a large number of technical challenges must be addressed before such a system can be deployed. These challenges include: (1) producing and deploying a large number of geographically distributed sensors; (2) rapidly detecting earthquakes based on signals obtained from the sensors; and (3) quickly warning affected people.

Hence, what is needed is an earthquake detection system that effectively addresses the above-listed technical challenges.

### SUMMARY

The disclosed embodiments relate to a system that detects earthquakes through a network of geographically distributed sensors. During operation, the system obtains inputs from sensors in the network of geographically distributed sensors. The system then determines from the obtained inputs whether an earthquake is occurring. During this process, the system associates a weight with each sensor, wherein the weight can correlated with: an accuracy of the sensor, ambient noise associated with the sensor, a mounting fixture for the sensor, and past statistics of false positives for the sensor. The system then applies the weight to inputs obtained from the sensor while performing computations to determine whether an earthquake is occurring. If an earthquake is occurring, the system sends a warning to one or more subscribers.

In some embodiments, the system dynamically updates a weight associated with each sensor in the network based on a rate of false positives associated with inputs obtained from the sensor.

In some embodiments, obtaining the inputs from the sensors includes receiving triggers sent by the sensors, wherein a trigger is sent by a sensor when the sensor detects a trigger condition indicating that an earthquake may be occurring.

In some embodiments, the trigger condition can include one or more of the following: (1) an accelerometer output from the sensor exceeds a threshold in a frequency range associated with earthquakes; (2) one or more zero crossings are detected in the accelerometer output from the sensor; (3) a change in a periodicity of a slope polarity is detected in the accelerometer output from the sensor; and (4) a signal above a dynamically generated background noise threshold for the sensor.

In some embodiments, if the trigger was sent by the sensor to a server, and the sensor determines from subsequently received data that the trigger was not associated with an earthquake, the sensor informs the server that the trigger was false.

In some embodiments, after sending the trigger to a server, the sensor subsequently sends additional sensor readings to the server, wherein the additional sensor readings are collected during a time window associated with the trigger condition.

In some embodiments, a weight associated with a sensor is determined based on one or more of the following: (1) an accuracy of previous inputs received from the sensor; (2) a sensor type of the sensor; (3) a location of the sensor; (4) a mounting fixture for the sensor; (5) an ambient noise associated with the sensor; and (6) statistics for false positives associated with the sensor.

In some embodiments, if a group of sensors in the network is located in close geographic proximity to each other, determining whether an earthquake is occurring involves ignoring inputs from all but one sensor in the group of sensors.

In some embodiments, if an earthquake is occurring, the method further comprises using triangulation and/or beam-forming techniques to determine an epicenter for the earthquake.

In some embodiments, sending the warning to the one or more subscribers includes sending the warning to subscribers who are located nearer to the epicenter first, before sending the warning to other subscribers who are located farther from the epicenter.

In some embodiments, after an epicenter is determined, the system directs inputs from sensors in the network to one or more servers that are geographically distant from the epicenter for subsequent processing.

In some embodiments, after an epicenter is determined, if an application that is processing inputs received from the sensors is operating on a server located in close geographic proximity to the epicenter, the application fails over to another server that is geographically distant from the epicenter.

In some embodiments, determining whether an earthquake is occurring involves looking for correlations between inputs received from multiple sensors in the network, wherein the correlations indicate that an earthquake is occurring. In some embodiments, the system looks for a positive correlation between the sensors in three dimenstions: time, location, and magnitude, wherein each of these positive correlations is necessary to detemine an overall correlation.

In some embodiments, in addition to sending the warning when the earthquake is detected, the system generates a shake map that indicates which areas are more susceptible to earthquake damage, and sends the shake map to the one or more subscribers.

In some embodiments, in addition to sending a warning when the earthquake is detected, the system also detects the peak ground acceleration (PGA) at the sensor and reports this to a subscriber. Note that the PGA can be combined with a fragility curve for a facility associated with the sensor to compute a probability of damage occurring to the facility as a consequence of the ground shaking.

In some embodiments, each sensor can include one or more of the following sensing mechanisms: an accelerometer; a microphone; a thermometer; a barometer, a humidity sensor, a CO sensor, a CO² sensor, a volatile gas sensor, a video-capture device, a scene-change detector, a chemical agent detector (nerve agent), and a radiation detector.

In some embodiments, a sensor comprises a smartphone with an accelerometer, wherein the smartphone runs an application that sends inputs associated with seismic events to a server.

In some embodiments, a sensor comprises a special-purpose hardware module that includes an accelerometer, wherein the special-purpose hardware module sends inputs associated with seismic events to a server.

In some embodiments, the sensor can detect an abnormal shake pattern that can be attributed to abnormal vibrations that occur in the environment. For example, for a sensor located on or near a generator, a change in the peak periodicity of the vibration can be traced to bearing failure in the generator.

### BRIEF DESCRIPTION OF THE FIGURES

FIG. 1 illustrates an earthquake detection system in accordance with the disclosed embodiments.

FIG. 2A illustrates a special-purpose-hardware-module-based implementation of a sensor module in accordance with the disclosed embodiments.

FIG. 2B illustrates a mobile-device-based implementation of a sensor module in accordance with the disclosed embodiments.

FIG. 3 illustrates a triangulation computation in accordance with the disclosed embodiments.

FIG. 4 presents a flow chart illustrating the process of detecting an earthquake in accordance with the disclosed embodiments.

FIG. 5 presents a flow chart illustrating the process of generating a shake map in accordance with the disclosed embodiments.

FIG. 6 presents a flow chart illustrating the process of failing over an application to a server that is geographically distant from a detected epicenter in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Earthquake Detection System

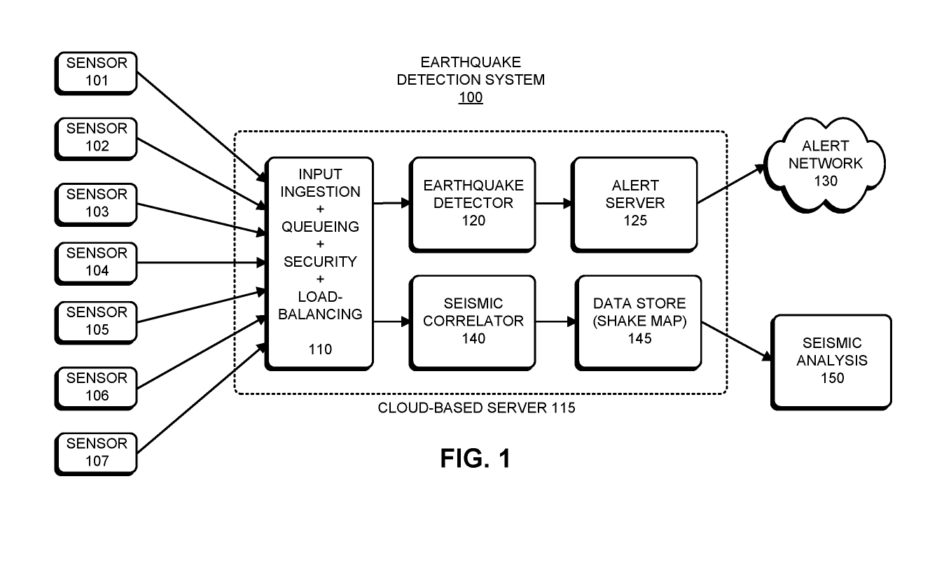

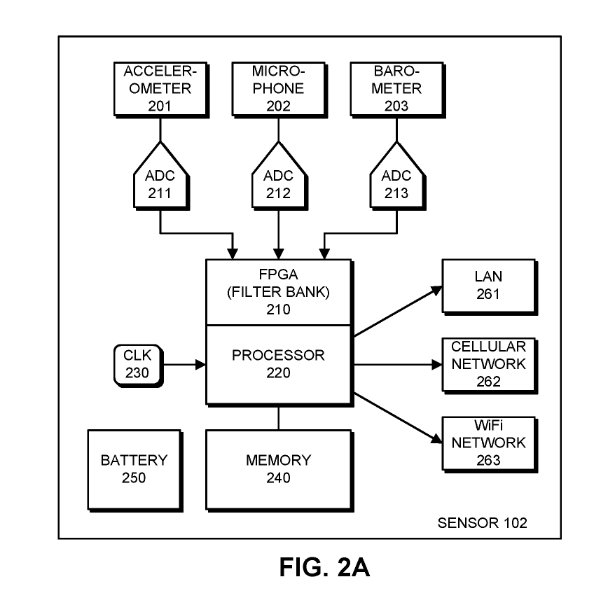

FIG. 1 illustrates an earthquake detection system 100 in accordance with the disclosed embodiments. Earthquake detection system 100 includes a set of geographically distributed sensors 101-107 that can each include one or more sensing mechanisms, such as an accelerometer, a microphone, a barometer and a thermometer. (The design of an exemplary sensor is described in more detail below with reference to FIG. 2A.) Inputs received from sensors 101-107 feed into a module 110 that is hosted in a cloud-based server 115. These received inputs includes “triggers” that are sent by sensors when the sensors detect a “trigger condition” indicating that an earthquake may be occurring. The inputs can also include a burst of consecutive sensor readings that are collected during a time window associated with the trigger condition.

Note that additional triggers can be generated whenever a given condition is met by one sensor device or a group of sensors. For example, a trigger can be sent to the server when the microphone detects an unusual loud report, such as a gun shot. A weather trigger can be sent whenever the atmospheric pressure reading falls below a set level. An air-quality trigger can be sent whenever the CO sensor and/or the CO² sensors detects high levels of CO and/or CO².

Note that because the system includes different types of sensors (accelerometer, microphone, etc.), it is possible to combine inputs from these different types of sensors through a process called “sensor fusion” to detect specific events. For example, shaking detected by an accelerometer can be correlated with audio signals obtained from a microphone to determine whether an intruder is entering a building where the sensors reside.

Module 110 performs various functions, such as: (1) ingesting inputs received from sensors 101-107; (2) queuing the inputs received from sensors 101-107; (3) performing security operations to ensure that inputs are received from valid sensors; and (4) performing load-balancing operations by directing the inputs to downstream servers for subsequent processing.

This load-balancing mechanism can optimize overall system throughput by sending newly received inputs to less busy servers. Moreover, the load-balancing mechanism can be used to send inputs to servers that are geographically distant from the epicenter of an earthquake for subsequent processing because servers that are located closer to the epicenter are more likely to go down.

Module 110 forwards the received triggers to an earthquake detector module 120, which can use various techniques described below to detect an earthquake based on the triggers. If an earthquake is detected, this information is passed on to an alert server 125 that sends corresponding alerts to subscribers through an alert network 130. Module 110 also forwards the alerts and associated sensor readings to a seismic correlator 140, which performs a more detailed analysis on the sensor readings, which for example can be used to produce a “shake map” that indicates which geographical areas are more susceptible to earthquakes. The results of this analysis can be stored in a data store 145, which can forward these results to a downstream seismic analysis module 150, and also to various subscribers, such as insurance companies who may be interested in the results.

### Sensor Module

FIG. 2A illustrates a stand-alone implementation of a sensor module 102 in accordance with the disclosed embodiments. This sensor module 102 can be implemented using a specially designed circuit board that includes various sensors, such as an accelerometer 201, a microphone 202 and a barometer 203. In one embodiment, accelerometer 201 comprises a low-cost tri-axial MEMS accelerometer. Note that sensor module 102 is not limited to the types of sensors illustrated in FIG. 2A. In general, sensor module 102 can include any type of sensor that can measure values of a physical parameter.

Analog inputs received through sensors 201-203 feed through analog-to-digital converts (ADCs) 211-213, respectively, to produce digital values that feed into a field-programmable gate array (FPGA) 210. FPGA 210 is programmed to operate as a filter bank for the digital signals received from DACs 211-213. In the most general case, the analog signals are conditioned and/or filtered. A typical case is when a low-pass filter (LPF) is used to eliminate aliasing artifacts. Note that this filtering can be tuned to facilitate observing specific artifacts.

The filtered inputs produced by FPGA 210 then feed into processor 220, which performs various operations on the filtered inputs and stores the results in memory 240. These results can be subsequently communicated to a remote server (such as cloud-based server 115 illustrated in FIG. 1), through various communication mechanisms, such as local-area network 261, cellular network 262 and Wi-Fi® network 263.

Communicating inputs to a remote server through the Internet may be problematic during a major earthquake because the local Internet infrastructure may fail due to power outages and other problems. However, even if the local Internet infrastructure fails, it is likely to take a significant amount of time to fail. This is because even in a massive earthquake, buildings associated with the Internet infrastructure will take some time to collapse. Also, region-wide power outages are rare, and even if a local power grid fails, it is likely to fail in a cascading manner that takes time to propagate throughout a region. Hence, it is likely that warnings can be sent to subscribers before the system fails. It is also possible to guard against the possibility of a communication failure by using satellite communications to communicate triggers and warnings instead of relying on landline-based communication networks.

Inputs received from sensors 201-203 are associated with timestamps that are determined with respect to a time base, such as a local clock 230, or a combination of local clock 230 and a synchronization protocol, such as the network-time protocol (NTP). Sensor module 102 also includes a power source, such as a rechargeable battery 250.

A sensor module can alternatively be implemented through an application running on a mobile device, such as a smartphone. For example, FIG. 2B illustrates a smartphone-based implementation of a sensor module in accordance with the disclosed embodiments. This type of implementation can be extremely cost-effective, because modern smartphones already include components that can be used to implement a sensor. For example smartphone 250 in FIG. 2B includes sensors, such as accelerometer 251 and microphone 252. Inputs received from these sensors can be processed using a processor 253 and a memory 254 to produce results that are communicated to a remote server through either Wi-Fi® network 257 or cellular network 258. These sensing operations are performed under control of an application 256, which can be easily distributed to a large number of smartphones. Hence, a smartphone-based implementation can be easily deployed to hundreds of thousands or even millions of sensors.

There are a number of challenges in creating a smartphone-based implementation that operates effectively. Because a smartphone is often carried by its owner, the accelerometer inside a smartphone will routinely experience accelerations that are not caused by an earthquake. Moreover, the computation-related and communication-related operations performed by application 256 can consume a significant amount of power, which can adversely affect the battery life of the smartphone. In order to mitigate these problems, application 256 can be configured to perform sensor operations only while smartphone 250 is charging and the smartphone battery is charged to a minimum level, say 75%. When smartphone 250 is charging, it is less likely to be experiencing accelerations due to being moved by its owner. Moreover, if the smartphone is charging, the owner is less likely to be concerned about a reduction in battery life. (However, the charging process may require a slightly longer amount of time if sensor operations are taking place.)

### Triangulation

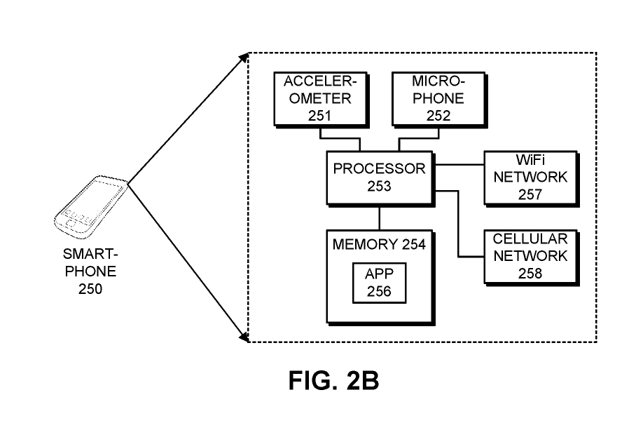

FIG. 3 illustrates a triangulation computation in accordance with the disclosed embodiments. In order to determine the epicenter for an earthquake, the system correlates triggers received from a set of geographically distributed sensors 101-103, and uses the difference in time delays t₁, t₂ and t₃ associated with three or more of the sensors to determine the location of the epicenter 302. Note that the accuracy of this determination depends on the accuracy of the time bases associated with each of the sensors. Because earthquakes have a maximum propagation speed through the earth, the system can determine that triggers received from a pair of sensors are not correlated if the distance between the sensors is not consistent with a possible propagation delay between the sensors. (The speed of propagation through the earth can be computed based on a function of a number of geological models for the earth's crust and the specific latitude and longitude of the sensors, wherein the function returns the average seismic velocity integrated from the surface to different crust depths. This velocity can be computed for both the S-wave and P-wave signals, and the velocity can be used for the correlation computation. During this process, the correlation engine can start at a zero crust depth and can iterate the solution for deeper and deeper epicenters, wherein the iteration stops at the mantle. In one embodiment, the system uses seven crust depth models.) Note that by determining that such triggers are not correlated, the system can decrease the number of false positive earthquake determinations.

Also note that while looking for such correlations, only recently received triggers are of interest. Triggers received more than 60 seconds ago are too old to provide a timely warning. Hence, the system only needs to maintain recently received triggers in memory.

### Process of Detecting an Earthquake

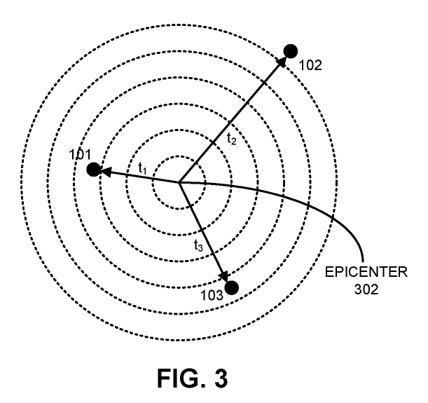

FIG. 4 presents a flow chart illustrating the process of detecting an earthquake through a network of geographically distributed sensors in accordance with the disclosed embodiments. During operation, the system receives triggers from sensors in the network of geographically distributed sensors, wherein a trigger is sent by a sensor when the sensor detects a trigger condition indicating that an earthquake may be occurring (step 402). For example, in one embodiment, each trigger specifies: (1) a location of the sensor (e.g., a latitude and a longitude); (2) a host identifier for the sensor; (3) a trigger identifier; (4) an acceleration value; and (5) other data values.

In some embodiments, if the trigger was sent by the sensor to a server, and the sensor determines from subsequently received data that the trigger was not associated with an earthquake, the sensor informs the server that the trigger was false. This enables the server to remove the trigger from memory, thereby reducing the rate of false positives.

The system also associates a weight with each sensor, wherein the weight is correlated with an accuracy of the sensor (step 404), and the system applies the weight to inputs obtained from the sensor while performing computations to determine whether an earthquake is occurring (step 406). By associating weights with each sensor, the system can make more accurate earthquake determinations. Some sensors that are located in a noisy environment, for example close to a freeway, may be more likely to generate false triggers than other sensors that are located in quiet environments. Hence, sensors that generate a significant percentage of false positive triggers can be associated with smaller weights because triggers received from such sensors are less reliable. Note that a weight for a sensor can be determined based on a number of factors, such as: (1) the accuracy of previous inputs received from the sensor; (2) the sensor type; (3) the location of the sensor, and (4) how the sensor is fixed to the facility. These weights can also be “dynamic,” which means that they can be periodically updated as more triggers are received from the sensors and the triggers are determined to be valid or false positive.

In one embodiment, the system requires a minimum of three sensors to detect an earthquake. To improve accuracy, the weighting technique described above can be enhanced by increasing the number of correlations required to identify an earthquake. For example, a smartphone-based sensor may be considered to be less reliable than a special-purpose fixed sensor module. Hence, the system may require a correlation between 10 smartphone-based sensors to make an earthquake determination, whereas the system may only require a correlation between three fixed sensor modules to make an earthquake determination.

Also, if a group of sensors is located in close geographic proximity to each other (e.g., within 100-300 meters of each other), it is not useful to correlate data received from such sensors because: (1) the data received from such sensors is redundant, and (2) the time delays between triggers received from such sensors are too small to be useful in performing triangulation computations. In this case, the system can simply ignore triggers received from all but one of the group of geographically close sensors.

Note that a sensor can use various criteria in deciding whether to send a trigger. For example, a trigger condition can include one or more of the following: (1) an accelerometer output from the sensor exceeds a threshold in a frequency range associated with earthquakes; (2) one or more zero crossings are detected in the accelerometer output from the sensor; (3) a change in a periodicity of a slope polarity is detected in the accelerometer output from the sensor; and (4) a signal above a dynamically generated background noise threshold for the sensor.

Finally, if an earthquake is occurring, the system sends a warning in the form of an alert to one or more subscribers (step 408). Note that if a subscriber is located at the epicenter, the subscriber may not receive an alert in time to take evasive action. Moreover, the sending of the warnings can be prioritized, so that warnings are sent to subscribers who are located nearer to the epicenter first, before sending warnings to other subscribers who are located farther from the epicenter.

A warning will give the subscriber some amount of time (e.g., 10-15 seconds) to take an evasive action. There exist a large number of possible evasive actions, such as taking cover, stopping a train, shutting off a gas main, shutting down an electrical power grid, or opening a garage door at a fire station, so that a fire truck does not get stuck in the garage.

It can also be challenging to perform a mass notification quickly enough to give subscribers a 10-15 second advance warning of an impending earthquake. Note that it is possible to use an existing system to communicate a mass warning, such as the national Emergency Alert System (EAS), which is jointly coordinated by the Federal Emergency Management Agency (FEMA), the Federal Communications Commission (FCC) and the National Weather Service (NOAA/NWS). It is also possible to use a “push notification infrastructure” to send alerts to smartphones that use the Android™ or IOS™ operating systems.

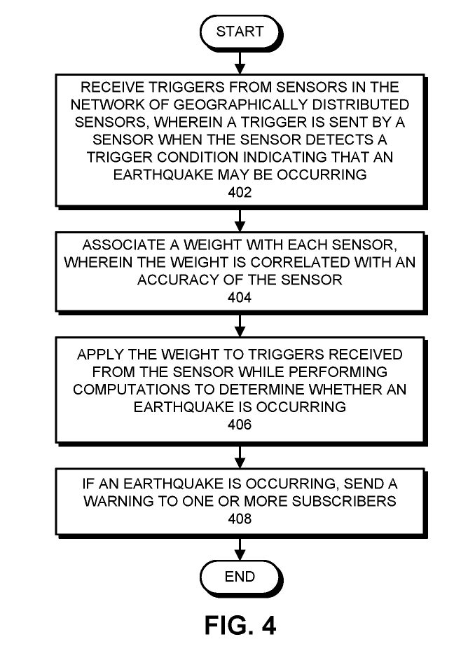

FIG. 5 presents a flow chart illustrating the process of generating a shake map in accordance with the disclosed embodiments. When an earthquake has occurred, in addition to receiving triggers, the system also receives sensor readings from the sensors (step 502). For example, after a trigger occurs, the sensor can send a 30 second stream of sensor readings gathered at 0.5 second intervals. Note that triggers are extremely time-critical and, hence, need to be sent through a low-latency communication channel. However, these additional sensor readings are less time-critical and can possibly be sent through a separate communication channel that does not have low-latency requirements.

Next, the system uses the received sensor readings to generate a shake map that indicates which areas are more susceptible to earthquakes (step 504), and sends the shake map to one or more subscribers (step 506). Note that as additional data is received, the shake map can be improved. Hence, in some embodiments, the system quickly sends a low-resolution shake map to subscribers in case the system goes down. Next, the system sends updated higher-resolution shake maps to the subscribers as the resolution of the shake map improves.

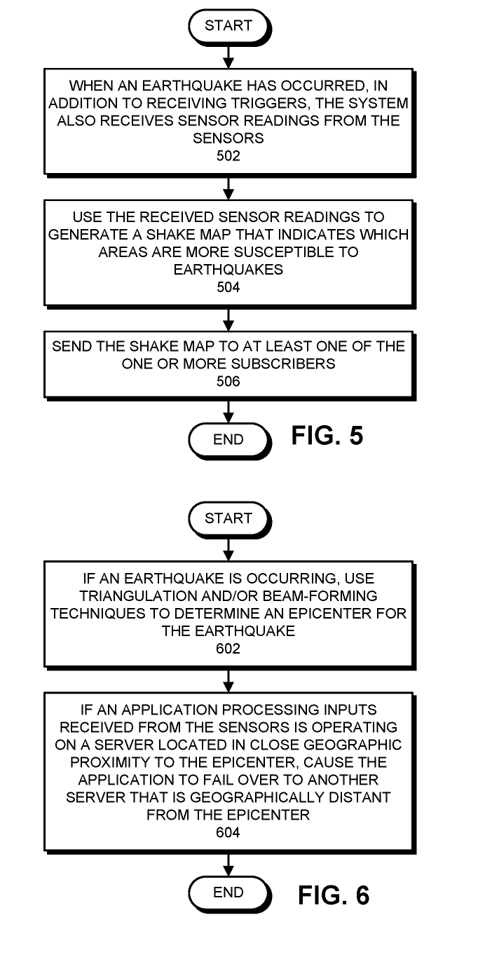

FIG. 6 presents a flow chart illustrating the process of failing over an application to a server that is geographically distant from a detected epicenter in accordance with the disclosed embodiments. When an earthquake is occurring, the system uses triangulation and/or beam-forming techniques to determine an epicenter for the earthquake (step 602). Next, if an application that is processing inputs received from the sensors is operating on a server located in close geographic proximity to the epicenter, the system causes the application to fail over to another server that is geographically distant from the epicenter (step 604).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for detecting earthquakes through a network of geographically distributed sensors, comprising:
obtaining inputs from sensors in the network of geographically distributed sensors;
determining from the obtained inputs whether an earthquake is occurring by,
associating a weight with each sensor, wherein the weight is correlated with an accuracy of the sensor, and
applying the weight to inputs obtained from the sensor while performing computations to determine whether an earthquake is occurring; and
if an earthquake is occurring, sending a warning to one or more subscribers.

2. The method of claim 1, wherein the method further comprises dynamically updating a weight associated with each sensor in the network of geographically distributed sensors based on a rate of false positives associated with inputs obtained from the sensor.

3. The method of claim 1, wherein obtaining the inputs from the sensors includes receiving triggers sent by the sensors, wherein a trigger is sent by a sensor when the sensor detects a trigger condition indicating that an earthquake may be occurring.

4. The method of claim 3, wherein the trigger condition can include one or more of the following:
an accelerometer output from the sensor exceeds a threshold in a frequency range associated with earthquakes;
one or more zero crossings are detected in the accelerometer output from the sensor;
a change in a periodicity of a slope polarity is detected in the accelerometer output from the sensor; and
a signal above a dynamically generated background noise threshold for the sensor.

5. The method of claim 3, wherein if the trigger was sent by the sensor to a server, and the sensor determines from subsequently received data that the trigger was not associated with an earthquake, the sensor informs the server that the trigger was false.

6. The method of claim 3, wherein after sending the trigger to a server, the sensor subsequently sends additional sensor readings to the server, wherein the additional sensor readings are collected during a time window associated with the trigger condition.

7. The method of claim 1, wherein a weight associated with a sensor is determined based on one or more of the following:
an accuracy of previous inputs received from the sensor;
a sensor type of the sensor;
a location of the sensor; and
a method of fixing the sensor to a structure.

8. The method of claim 1, wherein if a group of sensors in the network is located in close geographic proximity to each other, determining whether an earthquake is occurring involves ignoring inputs from all but one sensor in the group of sensors.

9. The method of claim 1, wherein if an earthquake is occurring, the method further comprises using triangulation and/or beam-forming techniques to determine an epicenter for the earthquake.

10. The method of claim 9, wherein sending the warning to the one or more subscribers includes sending the warning to subscribers who are located nearer to the epicenter first, before sending the warning to other subscribers who are located farther from the epicenter.

11. The method of claim 9, wherein after an epicenter is determined, the method further comprises directing inputs from sensors in the network to one or more servers that are geographically distant from the epicenter for subsequent processing.

12. The method of claim 9, wherein after an epicenter is determined, if an application that is processing inputs received from the sensors is operating on a server located in close geographic proximity to the epicenter, the application fails over to another server that is geographically distant from the epicenter.

13. The method of claim 1, wherein determining whether an earthquake is occurring involves looking for correlations between inputs received from multiple sensors in the network, wherein the correlations indicate that an earthquake is occurring.

14. The method of claim 1, wherein in addition to sending the warning when the earthquake is detected, the method further comprises:
generating a shake map that indicates which areas are more susceptible to earthquakes; and
sending the shake map to at least one of the one or more subscribers.

15. The method of claim 1, wherein each sensor can include one or more of the following sensing mechanisms:
an accelerometer;
a microphone;
a thermometer;
a barometer;
a humidity sensor;
a CO sensor;
a CO² sensor;
a volatile gas sensor;
a video capture device;
a scene-change detector;
a chemical agent detector; and
a radiation detector.

16. The method of claim 1,
wherein a sensor comprises a smartphone with an accelerometer; and
wherein the smartphone runs an application that sends inputs associated with seismic events to a server.

17. The method of claim 1,
wherein a sensor comprises a special-purpose hardware module that includes an accelerometer; and
wherein the special-purpose hardware module sends inputs associated with seismic events to a server.

18. A non-transitory computer-readable storage medium storing instructions that when executed by a computer cause the computer to perform a method for detecting earthquakes through a network of geographically distributed sensors, the method comprising:
obtaining inputs from sensors in the network of geographically distributed sensors;
determining from the obtained inputs whether an earthquake is occurring by,
associating a weight with each sensor, wherein the weight is correlated with an accuracy of the sensor, and
applying the weight to inputs obtained from the sensor while performing computations to determine whether an earthquake is occurring; and
if an earthquake is occurring, sending a warning to one or more subscribers.

19. The non-transitory computer-readable storage medium of claim 18, wherein the method further comprises dynamically updating a weight associated with each sensor in the network of geographically distributed sensors based on a rate of false positives associated with inputs obtained from the sensor.

20. The non-transitory computer-readable storage medium of claim 18, wherein obtaining the inputs from the sensors includes receiving triggers sent by the sensors, wherein a trigger is sent by a sensor when the sensor detects a trigger condition indicating that an earthquake may be occurring.

21. The non-transitory computer-readable storage medium of claim 20, wherein the trigger condition can include one or more of the following:
an accelerometer output from the sensor exceeds a threshold in a frequency range associated with earthquakes;
one or more zero crossings are detected in the accelerometer output from the sensor;
a change in a periodicity of a slope polarity is detected in the accelerometer output from the sensor; and
a signal above a dynamically generated background noise threshold for the sensor.

22. The non-transitory computer-readable storage medium of claim 20, wherein if the trigger was sent by the sensor to a server, and the sensor determines from subsequently received data that the trigger was not associated with an earthquake, the sensor informs the server that the trigger was false.

23. The non-transitory computer-readable storage medium of claim 20, wherein after sending the trigger to a server, the sensor subsequently sends additional sensor readings to the server, wherein the additional sensor readings are collected during a time window associated with the trigger condition.

24. The non-transitory computer-readable storage medium of claim 18, wherein a weight associated with a sensor is determined based on one or more of the following:
an accuracy of previous inputs received from the sensor;
a sensor type of the sensor;
a location of the sensor; and
a method of fixing the sensor to a structure.

25. The non-transitory computer-readable storage medium of claim 18, wherein if a group of sensors in the network is located in close geographic proximity to each other, determining whether an earthquake is occurring involves ignoring inputs from all but one sensor in the group of sensors.

26. The non-transitory computer-readable storage medium of claim 18, wherein if an earthquake is occurring, the method further comprises using triangulation and/or beam-forming techniques to determine an epicenter for the earthquake.

27. The non-transitory computer-readable storage medium of claim 26, wherein sending the warning to the one or more subscribers includes sending the warning to subscribers who are located nearer to the epicenter first, before sending the warning to other subscribers who are located farther from the epicenter.

28. The non-transitory computer-readable storage medium of claim 26, wherein after an epicenter is determined, the method further comprises directing inputs from sensors in the network to one or more servers that are geographically distant from the epicenter for subsequent processing.

29. The non-transitory computer-readable storage medium of claim 26, wherein after an epicenter is determined, if an application that is processing inputs received from the sensors is operating on a server located in close geographic proximity to the epicenter, the application fails over to another server that is geographically distant from the epicenter.

30. The non-transitory computer-readable storage medium of claim 18, wherein determining whether an earthquake is occurring involves looking for correlations between inputs received from multiple sensors in the network, wherein the correlations indicate that an earthquake is occurring.

31. The non-transitory computer-readable storage medium of claim 18, wherein in addition to sending the warning when the earthquake is detected, the method further comprises:
generating a shake map that indicates which areas are more susceptible to earthquakes; and
sending the shake map to at least one of the one or more subscribers.

32. The non-transitory computer-readable storage medium of claim 18, wherein each sensor can include one or more of the following sensing mechanisms:
an accelerometer;
a microphone;
a thermometer;
a barometer;
a humidity sensor;
a CO sensor;
a CO² sensor;
a volatile gas sensor;
a video capture device;
a scene-change detector;
a chemical agent detector; and
a radiation detector.

33. The non-transitory computer-readable storage medium of claim 18,
wherein a sensor comprises a smartphone with an accelerometer; and
wherein the smartphone runs an application that sends inputs associated with seismic events to a server.

34. The non-transitory computer-readable storage medium of claim 18,
wherein a sensor comprises a special-purpose hardware module that includes an accelerometer; and
wherein the special-purpose hardware module sends inputs associated with seismic events to a server.

35. A distributed system that detects earthquakes through a network of geographically distributed sensors, comprising:
an earthquake-detection mechanism that operates in a computing node in the distributed system;
wherein during operation, the earthquake-detection mechanism,
obtains inputs from sensors in the network of geographically distributed sensors;
determines from the obtained inputs whether an earthquake is occurring by,
associating a weight with each sensor, wherein the weight is correlated with an accuracy of the sensor, and
applying the weight to inputs obtained from the sensor while performing computations to determine whether an earthquake is occurring; and
if an earthquake is occurring, sends a warning to one or more subscribers.

36. The distributed system of claim 35, wherein the earthquake-detection mechanism dynamically updates a weight associated with each sensor in the network of geographically distributed sensors based on a rate of false positives associated with inputs obtained from the sensor.

37. The distributed system of claim 35, wherein while obtaining the inputs from the sensors, the earthquake-detection mechanism receives triggers sent by the sensors, wherein a trigger is sent by a sensor when the sensor detects a trigger condition indicating that an earthquake may be occurring.

38. The distributed system of claim 37, wherein if the trigger was sent by the sensor to a server, and the sensor determines from subsequently received data that the trigger was not associated with an earthquake, the sensor informs the server that the trigger was false.

39. The distributed system of claim 37, wherein after sending the trigger to a server, the sensor subsequently sends additional sensor readings to the server, wherein the additional sensor readings are collected during a time window associated with the trigger condition.

40. The distributed system of claim 35, wherein if a group of sensors in the network is located in close geographic proximity to each other, while determining whether an earthquake is occurring, the earthquake-detection mechanism ignores inputs from all but one sensor in the group of sensors.

41. The distributed system of claim 35, wherein if an earthquake is occurring, the earthquake-detection mechanism uses triangulation and/or beam-forming techniques to determine an epicenter for the earthquake.

42. The distributed system of claim 41, wherein while sending the warning to the one or more subscribers, the earthquake detection mechanism sends the warning to subscribers who are located nearer to the epicenter first, before sending the warning to other subscribers who are located farther from the epicenter.

43. The distributed system of claim 41, wherein after an epicenter is determined, if an application that is processing inputs received from the sensors is operating on a server located in close geographic proximity to the epicenter, the application fails over to another server that is geographically distant from the epicenter.

44. The distributed system of claim 35, wherein in addition to sending the warning when the earthquake is detected, the earthquake-detection mechanism:
generates a shake map that indicates which areas are more susceptible to earthquakes; and
sends the shake map to at least one of the one or more subscribers.
